(19) United States
(12) Patent Application Publication
(10) Pub. No.: US 2023/0040692 A1
(43) Pub. Date: Feb. 9, 2023

(54) WIRE HARNESS

(71) Applicant: SUMITOMO WIRING SYSTEMS, LTD., Yokkaichi-shi (JP)

(72) Inventors: Katsuhiro IWAMOTO, Yokkaichi-shi (JP); Yusuke KITO, Yokkaichi-shi (JP)

(73) Assignee: SUMITOMO WIRING SYSTEMS, LTD., Yokkaichi-shi (JP)

(21) Appl. No.: 17/879,395

(22) Filed: Aug. 2, 2022

(30) Foreign Application Priority Data
Aug. 5, 2021 (JP) 2021-129146

(51) Int. Cl. H01B 7/18; H01B 7/00; B60R 16/02

(52) U.S. Cl. CPC H01B 7/1805; H01B 7/0045; B60R 16/0215

(57) ABSTRACT

A wire harness including: a first wire that is electrically connectable to a first connector installed in a vehicle; a second wire that is electrically connected to the first wire; a third. wire that is electrically connected to the first wire; a connection where the first wire, the second wire, and the third wire are electrically connected to each other; and a tubular first shield that surrounds an outer periphery of. the connection.

### BACKGROUND

The present disclosure relates to a wire harness.

Wire harnesses that include shielded wires are conventionally known. as wire harnesses installed inside vehicles such as hybrid vehicles and electric vehicles (see JP 2004-296418A, for example). A shielded wire includes a conductive core wire, an insulating covering that surrounds the outer periphery of the core wire, a braided wire that surrounds the outer periphery of the insulating covering, and a sheath that surrounds the outer periphery of the braided wire. The braided wire has an electromagnetic shielding function of suppressing the radiation of electromagnetic waves (electromagnetic noise) from the core wire to the outside of the shielded wire.

### SUMMARY

There is demand for suppressing a reduction in the electromagnetic shielding performance of the wire harness described above, and there is still room for improvement in this respect.

An exemplary aspect of the disclosure provides a wire harness that can suppress a reduction in the electromagnetic shielding performance.

A wire harness including: a first wire that is electrically connectable to a first connector installed in a vehicle; a second wire that is electrically connected to the first wire; a third wire that is electrically connected to the first wire; a connection where the first wire, the second wire, and the third wire are electrically connected to each other; and a tubular first shield that surrounds an outer periphery of the connection, wherein: an opening is provided in an intermediate portion in an axial direction of the first shield, the second wire is a shielded wire that includes a tubular second shield, the first shield surrounds an outer periphery of a portion of the second shield, and a second-shield-side first end in an axial direction of the second shield is drawn to an outside of the first shield from the opening.

The wire harness according to the present disclosure has an effect of suppressing a reduction in the electromagnetic shielding performance.

### BRIEF DESCRIPTION OF THE DRAWINGS

FIG. 1 is a schematic configuration diagram showing a wire harness according to an embodiment;

FIG. 2 is a schematic configuration diagram showing the wire harness according to an embodiment;

FIG. 3 is a schematic configuration iagram showing the wire harness according to an embodiment;

FIG. 4 is a schematic cross-sectional view (cross-sectional view taken along line 4-4 in FIGS. 2 and 3) showing the wire harness according to an embodiment;

FIG. 5 is a schematic cross-sectional view (cross-sectional view taken along line 5-5 in FIGS. 2 and 3) showing the wire harness according to an embodiment;

FIG. 6 is a schematic configuration diagram showing a wire harness according to a variation;

FIG. 7 is a schematic configuration diagram showing a wire harness according to a variation; and

FIG. 8 is a schematic configuration diagram showing a wire harness according to a variation.

### DETAILED DESCRIPTION OF EMBODIMENTS

### Description of Embodiments of the Present Disclosure

First, embodiments of the present disclosure will be listed and described.

[1] A wire harness according to the present disclosure includes: a first wire that is electrically connectable to a first connector installed in a vehicle; a second wire that is electrically connected to the first wire; a third wire that is electrically connected to the first wire; a connection portion in which the first wire, the second wire, and the third wire are electrically connected to each other; a tubular first shield member that surrounds the outer periphery of the connection portion; and an opening that is provided in an intermediate portion in an axial direction of the first shield member, wherein the second wire is a shielded wire that includes a tubular second shield member, the first shield member surrounds the outer periphery of a portion of the second shield member, and a second-shield-side first end portion in an axial direction of the second shield member is drawn to the outside of the first shield member from the opening.

This configuration includes the tubular first shield member that surrounds the outer periphery of the connection portion in which the first wire, the second wire, and the third wire are electrically connected to each other. In the connection portion, a core wire of the second wire exposed from the second shield member is electrically connected to the first wire and the third wire. Accordingly, the core wire of the second wire is not surrounded by the second shield member in the connection portion. Therefore, in the connection portion, the second shield member does not serve as an electromagnetic shield for the second wire. However, in the wire harness of the present disclosure, the outer periphery of the connection portion is surrounded by the first shield member other than the second shield member. Accordingly, in the connection portion, the first shield member serves as an electromagnetic shield for the second wire exposed from the second shield member. Therefore, it is possible to favorably suppress a reduction in the electromagnetic shielding performance in the connection portion. Consequently, the radiation of electromagnetic waves (electromagnetic noise) generated in the connection portion to the outside of the wire harness can he favorably suppressed.

Moreover, the second-shield-side first end portion of the second shield member is drawn to the outside of the first shield member from the opening provided in the intermediate portion in the axial direction of the first shield member. With this configuration, the second shield member can be favorably electrically connected to a grounding portion outside the first shield member. Consequently, the second shield member can favorably function as an electromagnetic shield member.

Here, the axial direction of the first shield member is the direction in which the center axis of the first shield member extends, and the axial direction of the second shield member is the direction in which the center axis of the second shield member extends. “Tubular” as used in the description of the present specification means not only the shape of a peripheral wall that is continuously formed over the entire circumferential direction thereof but also a tubular shape formed by a plurality of combined parts and a shape in which a portion in the circumferential direction thereof includes a notch or the like, such as a C-shape. Also, “tubular” shapes include circular shapes, elliptical shapes, and polygonal shapes including angular or rounded corners.

[2] It is preferable that; the first wire includes a conductive first core wire and a first insulating covering that surrounds the outer periphery of the first core wire and has insulating properties; the second wire includes a conductive second core wire, a second insulating covering that surrounds the outer periphery of the second core wire and has insulating properties, the second shield member that surrounds the outer periphery of the second insulating covering and is conductive, and a first sheath that surrounds the outer periphery of the second shield member and has insulating properties; the third wire includes a conductive third core wire, a third insulating covering that surrounds the outer periphery of the third core wire and has insulating properties, a tubular third shield member that surrounds the outer periphery of the third insulating covering and is conductive, and a second sheath that surrounds the outer periphery of the third shield member and has insulating properties; in the 25, connection portion, the first core wire exposed from the first insulating covering, the second core wire exposed from the second insulating covering, the second shield member, and the first sheath, and the third core wire exposed from the third insulating covering, the third shield member, and the second sheath are electrically connected to each other; the first shield member surrounds the outer periphery of a portion of the third shield member; and a third-shield-side first end portion in an axial direction of the third shield member is drawn to the outside of the first shield member from the opening.

In this configuration, the first core wire exposed from the first insulating covering, the second core wire exposed from the second insulating covering, the second shield member, and the first sheath, and the third core wire exposed from the third insulating covering, the third shield member, and the second sheath are electrically connected to each other in the connection portion. Accordingly, in the connection portion, the second core wire is not surrounded by the second shield member, and the third core wire is not surrounded by the third shield member. Therefore, in the connection portion, the second shield member does not serve as an electromagnetic shield for the second core wire, and the third shield member does not serve as an electromagnetic shield for the third core wire. However, in the wire harness of the present disclosure, the outer periphery of the connection portion is surrounded by the first shield member other than the second shield member and the third shield member. Accordingly, in the connection portion, the first shield member serves as an electromagnetic shield for the second core wire exposed from the second shield member and the third core wire exposed from the third shield member. Therefore, it is possible to favorably suppress a reduction in the electromagnetic shielding performance in the connection portion. Moreover, the third-shield-side first end portion of the third shield member is drawn to the outside of the first shield member from the opening provided in the intermediate portion in the axial direction of the first shield member. With this configuration, the third shield member can be favorably electrically connected to a grounding portion outside the first shield member. Consequently, the third shield member can favorably function as an electromagnetic shield member.

[3] It is preferable that: the second-shield-side first end portion of the second shield member is exposed from the first sheath; the second-shield-side first end portion of the second shield member includes a first separated portion that does not surround the outer peripheries of the second core wire and the second insulating covering and extends away from the second core wire and the second insulating covering; the third-shield-side first end portion of the third shield member is exposed from the second sheath; the third-shield-side first end portion of the third shield member includes a second separated portion that does not surround the outer peripheries of the third core wire and the third insulating covering and extends away from the third core wire and the third insulating covering; the first shield member surrounds the outer periphery of the second core wire exposed from the second shield member and the outer periphery of the third core wire exposed from the third shield member; and the first separated portion and the second separated portion are drawn to the outside of the first shield member from the opening.

In this configuration, the outer periphery of the second core wire exposed from the second shield member and the outer periphery of the third core wire exposed from the third shield member are surrounded by the first shield member. Therefore, the first shield member serves as an electromagnetic shield for the second core wire exposed from the second shield member and the third core wire exposed from the third shield member. Consequently, a reduction in the electromagnetic shielding performance can be favorably suppressed in the region from the first separated portion and the second separated portion to the connection portion.

[4] It is preferable that the first shield member surrounds the outer periphery of a portion of the first sheath and the outer periphery of a portion of the second sheath. In this configuration, the outer peripheries of the first sheath and the second sheath are surrounded by the first shield member. Therefore, in the length directions of the second wire and the third wire, the region from the connection portion to the first sheath and the second sheath can be surrounded the first shield member. Here, the first sheath surrounds the outer periphery of the second shield member, and the second sheath surrounds the outer periphery of the third shield member. Accordingly, the region from a portion of the second core wire surrounded by the second shield member and the first sheath to the connection portion can be surrounded by the first shield member. Also, the region from a portion of the third core wire surrounded by the third shield member and the second sheath to the connection portion can be surrounded by the first shield member. Therefore, it is possible to favorably suppress a reduction in the electromagnetic shielding performance in the region from the connection portion to the first sheath and the second sheath.

[5] It is preferable that the first wire is an unshielded wire that does not have its own electromagnetic shielding structure, and the first shield member surrounds the outer periphery of the first wire. In this configuration, the outer periphery of the first wire that is an unshielded wire is surrounded by the first shield member. Therefore, the first shield member can favorably serve as an electromagnetic shield for the first wire. In other words, even in the case where the first wire is an unshielded wire, the first shield member serves as an electromagnetic shield for the first wire, and therefore, it is possible to favorably suppress a reduction in the electromagnetic shielding performance.

[6] It is preferable that the wire harness further includes a grounding member that electrically connects the second-shield-side first end portion of the second shield member and the third-shield-side first end portion of the third shield member collectively to a grounding portion. In this configuration, the second-shield-side first end portion of the second shield member and the third-shield-side first end portion of the third shield member are collectively electrically connected to the grounding portion. Therefore, when compared with a case where the second-shield-side first end portion and the third-shield-side first end portion are electrically connected to different grounding portions, the number of connections to grounding portions, i.e., the number of grounding sites can be reduced.

[7] It is preferable that the grounding member electrically connects a first-shield-side first end portion in the axial direction of the first shield member, the second-shield-side first end portion of the second shield member, and the third-shield-side first end portion of the third shield member collectively to the grounding portion. In this configuration, the first-shield-side first end portion of the first shield member, the second-shield-side first end portion of the second shield member, and the third-shield-side first end portion of the third shield member are collectively electrically connected to the grounding portion. Therefore, the number of grounding sites can be further reduced when compared with a case where the first-shield-side first end portion, the second-shield-side first end portion, and the third-shield-side first end portion are electrically connected to different grounding portions.

[8] It is preferable that the grounding member includes a first earth. terminal that is electrically connected to the second-shield-side first end portion of the second shield member, a second earth terminal that is electrically connected to the third-shield-side first end portion of the third shield member, and a second connector that is electrically connected to the first earth terminal. and the second earth terminal in this configuration, the first earth terminal electrically connected to the second-shield-side first end portion and the second earth terminal electrically connected to the third-shield-side first end portion are connected to the second connector. Therefore, it is possible to electrically connect the second-shield-side first end portion and the third-shield-side first end portion collectively to the grounding portion by electrically connecting the second connector to the grounding portion.

[9] It is preferable that the first connector is electrically connectable to an external connector that is connected to an external power source. In this configuration, the first connector that is electrically connected to the first wire is electrically connected to the external connector and the external power source. In the wire harness of this case, a large current flows through the first wire, and accordingly, electromagnetic noise is likely to be generated in the first wire and the connection portion, for example. However, in the wire harness of the present disclosure, the outer periphery of the connection portion is surrounded by the first shield member to suppress a reduction in the electromagnetic shielding performance in the connection portion. Therefore, even in the case where electromagnetic noise is likely to be generated, it is possible to favorably suppress the radiation of electromagnetic noise generated from the connection portion to the outside of the wire harness.

### Details of Embodiments of the Present Disclosure

A specific example of a wire harness according to the present disclosure will be described below with reference to the drawings. In the drawings, a portion of the configuration may be emphasized or simplified for the sake of convenience of description. Dimensional ratios of portions may differ between drawings. “Orthogonal” as used in the present specification encompasses not only the strict sense of the word “orthogonal” but also the meaning of “substantially orthogonal” within a range in which operations and effects of the present embodiment can be achieved. Note that the present disclosure is not limited to the following examples, but is defined by the claims, and is intended to encompass all modifications within the meanings and scope that are equivalent to the claims.

### Overall Configuration of Wire Harness 1

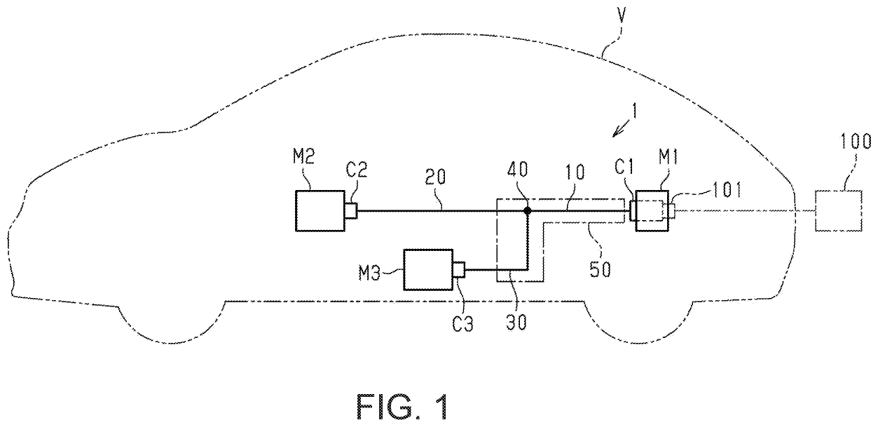

A wire harness 1 shown in FIG. 1 is installed in a vehicle V such as a hybrid vehicle or an electric vehicle, for example. The wire harness 1 electrically connects three or more in-vehicle devices. The in-vehicle devices are electrical devices installed in the vehicle V. The wire harness 1 of the present embodiment electrically connects a charging inlet M1 and a plurality of in-vehicle devices M2 and M3. The wire harness 1 is formed into an elongated shape so as to extend in the front-rear direction of the vehicle V, for example.

In the present embodiment, in the length direction of the wire harness 1, the side close to the charging inlet M1 will be referred to as the “rear side”, and the side close to the in-vehicle devices M2 and M3 will be referred to as the “front side” for the sake of convenience of description. Also, the charging inlet M1 side end portion of each member will be referred to as the “rear end portion”, and the in-vehicle device M2, M3 side end portion of each member will he referred to as the “front end portion”.

The wire harness 1 includes a wire 10, wires 20 and 30 that are electrically connected to the wire 10, a connection portion 40 in which the wire 10 is connected to the wires 20 and 30, and a shield member 50 that surrounds the outer periphery of the connection portion 40 (connection), for example. The wire harness 1 includes a connector C1 that is attached to the rear end portion of the wire 10, a connector C2 that is attached to the front end portion of the wire 20, and a connector C3 that is attached to the front end portion of the wire 30, for example.

The connector C1 is provided in the charging inlet M1, for example. The connector C1 constitutes a portion of the charging inlet M1, for example. In other words, the charging inlet M1 includes the connector C1, The connector C1 constituting the charging inlet M1 is electrically connectable to an external connector 101 that is connected to an external power source 100. The connector C2 is electrically connected to the in-vehicle device M2. The connector C3 is electrically connected to the in-vehicle device M3. The in-vehicle devices M2 and M3 are batteries, for example. The batteries are secondary batteries such as lithium-ion batteries, for example. It is possible to charge the batteries with power supplied from the external power source 100 by connecting the external connector 101 to the connector C1 of the charging inlet M1, for example, The battery capacity of the vehicle V can be increased by connecting a plurality of batteries to the charging inlet M1. As described above, the wire harness 1 of the present embodiment is a wire harness for charging that connects the in-vehicle devices M2 and M3, which are batteries, to the charging inlet M1.

In the wire harness 1, the two wires 20 and 30 branch from the single wire 10 at an intermediate portion in the length direction of the wire harness 1. In the wire harness 1 of the present embodiment, power supplied from the charging inlet M1 is distributed to the wires 20 and 30 and supplied via the wires 20 and 30 to the in-vehicle devices M2 and M3, which are batteries. In the wire harness 1, the wire 10 functions as a trunk wire and the wires 20 and 30 function as branch wires, for example. The wires 10, 20, and 30 are high-voltage wires that can withstand high voltages and large currents, for example.

### Configuration of Wire 10

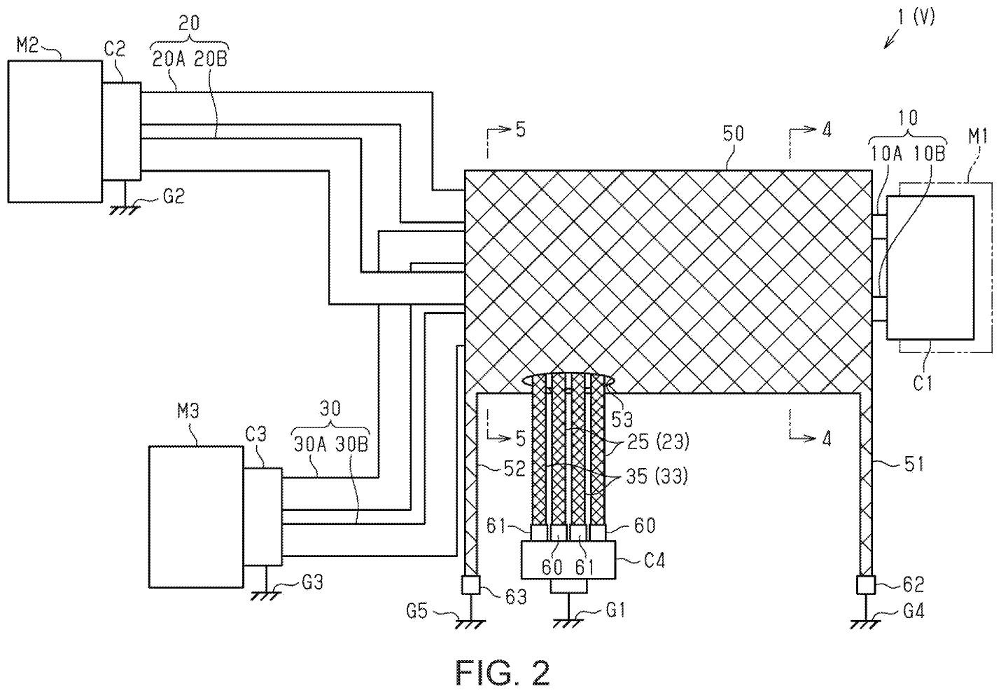

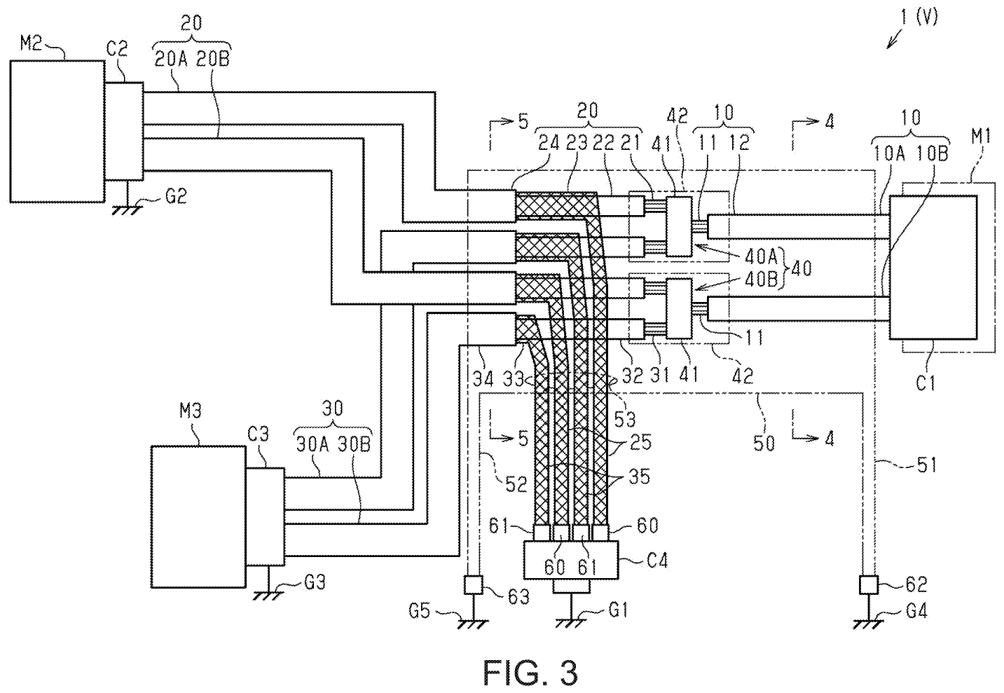

As shown in FIGS. 2 and 3, the wire 10 includes a plus side wire 10A and a minus side wire 10B, for example.

### Configuration of Wires 10A and 10B

As shown in FIG. 3, each of the wires 10A and 10B includes a conductive core wire 11 and an insulating covering 12 that surrounds the outer periphery of the core wire 11 and has insulating properties. The wires 10A and 10B are unshielded wires that do not have their own electromagnetic shielding structures, for example. The wires 10A and 10B are formed into elongated shapes so as to extend in the front-rear direction of the vehicle V, for example.

A twisted wire that is obtained by twisting a plurality of metal strands or a single core wire that is constituted by a single conductor can be used as the core wire 11, for example. A columnar conductor that is constituted by a single columnar metal rod having a solid structure or a tubular conductor that has a hollow structure can be used as the single core wire, for example, Any combination of a twisted wire, a columnar conductor, and a tubular conductor may also be used as the core wire 11. The core wire 11 in the present embodiment is a twisted wire. Metal materials such as copper-based materials and aluminum-based materials can be used as the material of the core wire 11, for example.

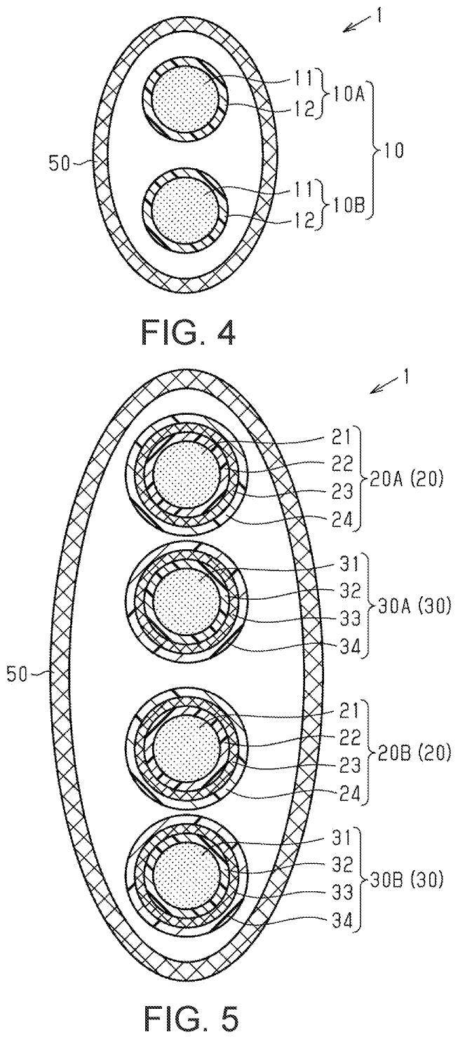

As shown in FIG. 4, the insulating covering 12 covers the outer circumferential surface of the core wire 11 over its entire circumference, for example. The insulating covering 12 is made of a resin material that has insulating properties, for example.

The shapes of cross sections of the wires 10A and 10B taken along a plane orthogonal to the length directions of the wires 10A and 10B, i.e., the shapes of transverse cross sections of the wires 10A and 10B are circular shapes, for example. The shapes of transverse cross sections of the wires 10A and 10B are not limited to circular shapes, and may he any shape such as semicircular shapes, polygonal shapes, square shapes, or flattened shapes, for example.

### Structure of End Portions in Length Direction of Wires 10A and 10B

As shown in FIG. 3, the front end portion of the core wire 11 is exposed from the insulating covering 12 at the front end portion of each of the wires 10A and 10B. At the front end portion of each of the wires 10A and 10B, the insulating covering 12 is removed by a predetermined length from the end of the wire 10A or 10B to expose the front end portion of the core wire 11.

### Configuration of Wire 20

The wire 20 includes a plus side wire 20A that is connected to the plus terminal of the in-vehicle device M2 and a minus side wire 20B that is connected to the minus terminal of the in-vehicle device M2, for example.

### Configuration of Wires 20A and 20B

Each of the wires 20A and 20B includes a conductive core wire 21 and an insulating covering 22 that surrounds the outer periphery of the core wire 21 and has insulating properties. Each of the wires 20A and 20B includes a tubular shield member 23 that surrounds the outer periphery of the insulating covering 22 and is conductive and a sheath 24 that surrounds the outer periphery of the shield member 23 and has insulating properties. The wires 20A and 20B in the present embodiment are shielded wires that have their own electromagnetic shielding structures. The wires 20A and 20B are formed into elongated shapes so as to extend in the front-rear direction of the vehicle V, for example.

A twisted wire, a columnar conductor, or a tubular conductor can he used as the core wire 21, for example. Any combination of a twisted wire, a columnar conductor, and a tubular conductor may also be used as the core wire 21. The core wire 21 in the present embodiment is a twisted wire. Metal materials such as copper-based materials and aluminum-based materials can be used as the material of the core wire 21, for example.

As shown in FIG. 5, the insulating covering 22 covers the outer circumferential surface of the core wire 21 over its entire circumference, for example. The insulating covering 22 is made of a resin material that has insulating properties, for example.

The shield member 23 surrounds the outer circumferential surface of the insulating covering 22 over its entire circumference, for example. The shield member 23 is flexible, for example. A braided wire that is obtained by braiding a plurality of metal strands into a tubular shape or a metal foil can be used as the shield member 23, for example. The shield member 23 in the present embodiment is a braided wire. Metal materials such as copper-based materials and aluminum-based materials can be used as the material of the shield member 23, for example.

The sheath 24 surrounds the outer circumferential surface of the shield member 23 over its entire circumference, for example. The sheath 24 is made of a resin material that has insulating properties, for example. The shapes of transverse cross sections of the wires 20A and 20B are circular shapes, for example. The shapes of transverse cross sections of the wires 20A and 20B are not limited to circular shapes, and may be any shape such as semicircular shapes, polygonal shapes, square shapes, or flattened shapes, for example.

### Structure of End Portions in Length Direction of Wires 20A and 20B

As shown in FIG. 3, the rear end portion of the core wire 21 is exposed from the insulating covering 22 at the rear end portion of each of the wires 20A and 20B. At the rear end portion of each of the wires 20A and 20B, the insulating covering 22 is removed by a predetermined length from the end of the wire 20A or 20B to expose the rear end portion of the core wire 21.

### Grounding Structure of Shield Member 23

Each shield member 23 is electrically connected to grounding portions of the vehicle V, e.g., grounding portions provided in a vehicle body panel or the like. That is, each shield member 23 is grounded to the grounding portions. Both end portions in the axial direction (length direction) of each shield member 23 are grounded, for example. The following describes an example of the grounding structure of the shield member 23.

At the rear end portion of each of the wires 20A and 20B, the rear end portion of the shield member 23 is exposed from the sheath 24. The rear end portion of the shield member 23 exposed from the sheath 24 includes a separated portion 25 (first separation) that does not surround the outer peripheries of the core wire 21 and the insulating covering 22 and extends away from the core wire 21 and the insulating covering 22. The separated portion 25 extends in a direction (downward in the drawing) that intersects the length direction of the core wire 21, for example. The separated portion 25 passes through the shield member 50 and is exposed to the outside of the shield member 50. The leading end of the separated portion 25 is electrically connected to a metal earth terminal 60, for example. Here, the leading end of the separated portion 25 is the end portion that is the farthest from the rear end portion of the sheath 24, out of end portions in the axial direction of the separated portion 25. The earth terminal 60 is electrically connected to a connector C4 for ground connection, for example. Two earth terminals 60 are connected to the common connector C4, for example. The connector C4 is grounded to a grounding portion G1 provided in the vehicle body panel or the like, for example. With this configuration, each separated portion 25 is grounded to the grounding portion G1 via the earth terminal 60 and the connector C4. The separated portion 25 and the earth terminal 60 can be joined by being crimped or welded through ultrasonic welding or laser welding, or using any other known joining method. Note that the front end portion of each shield member 23 is grounded to a grounding portion G2 provided in the vehicle body panel or the like via the connector C2, for example, although this is not illustrated. With the configuration described above, the shield members 23 exhibit an electromagnetic shielding function of suppressing the radiation of electromagnetic waves from the core wires 21 to the outside of the wires 20A and 20B.

Here, at the rear end portion of each of the wires 20A and 20B, the outer peripheries of portions of the insulating covering 22 and the core wire 21 that are located rearward of the separated portion 25 are not surrounded by the shield member 23. Accordingly, the shield member 23 does not serve as an electromagnetic shield for the rear end portions of the insulating covering 22 and the core wire 21 that are not surrounded by the shield member 23 and are exposed from the shield member 23.

### Configuration of Wire 30

The wire 30 includes a plus side wire 30A that is connected to the plus terminal of the in-vehicle device M3 and a minus side wire 30B that is connected to the minus terminal of the in-vehicle device M3, for example.

### Configuration of Wires 30A and 30B

Each of the wires 30A and 30B includes a conductive core wire 31 and an insulating covering 32 that surrounds the outer periphery of the core wire 31 and has insulating properties. Each of the wires 30A and 30B includes a tubular shield member 33 that surrounds the outer periphery of the insulating covering 32 and is conductive and a sheath 34 that surrounds the outer periphery of the shield member 33 and has insulating properties. The wires 30A and 30B in the present embodiment are shielded wires that have their own electromagnetic shielding structures. The wires 30A and 30B are formed into elongated shapes so as to extend in the front-rear direction of the vehicle V, for example.

A twisted wire, a columnar conductor, or a tubular conductor can be used as the core wire 31, for example, Any combination of a twisted wire, a columnar conductor, and a tubular conductor may also be used as the core wire 31. The core wire 31 in the present embodiment is a twisted wire. Metal materials such as copper-based materials and aluminum-based materials can be used as the material of the core wire 31, for example,

As shown in FIG. 5, the insulating covering 32 covers the outer circumferential surface of the core wire 31 over its entire circumference, for example. The insulating covering 32 is made of a resin material that has insulating properties, for example.

The shield member 33 surrounds the outer circumferential surface of the insulating covering 32 over its entire circumference, for example. The shield member 33 is flexible, for example. A braided wire or a metal foil can be used as the shield member 33, for example. The shield member 33 in the present embodiment is a braided wire. Metal materials such as copper-based materials and aluminum-based materials can be used as the material of the shield member 33, for example.

The sheath 34 surrounds the outer circumferential surface of the shield member 33 over its entire circumference, for example. The sheath 34 is made of a resin material that has insulating properties, for example.

The shapes of transverse cross sections of the wires 30A and 30B are circular shapes, for example, The shapes of transverse cross sections of the wires 30A and 30B are not limited to circular shapes, and may be any shape such as semicircular shapes, polygonal shapes, square shapes, or flattened shapes, for example.

### Structure of End Portions in Length Direction of Wires 30A and 30B

As shown in FIG. 3, the rear end portion of the core wire 31 is exposed from the insulating covering 32 at the rear end portion of each of the wires 30A and 3013. At the rear end portion of each of the wires 30A and 30B, the insulating covering 32 is removed by a predetermined length from the end of the wire 30A or 30B to expose the rear end portion of the core wire 31.

### Grounding Structure of Shield Member 33

Each shield member 33 is grounded to grounding portions provided in the vehicle body panel or the like. Both end portions in the axial direction (length direction) of each shield member 33 are grounded, for example. The following describes an example of the grounding structure of the shield member 33.

The rear end portion of the shield member 33 is exposed from the sheath 34 at the rear end portion of each of the wires 30A and 30B. The rear end portion of the shield member 33 exposed from the sheath 34 includes a separated portion 35 (second separation) that does not surround the outer peripheries of the core wire 31 and the insulating covering 32 and extends away from the core wire 31 and the insulating covering 32. The separated portion 35 extends in a direction (downward in the drawing) that intersects the length direction of the core wire 31, for example. The separated portion 35 passes through the shield member 50 and is exposed to the outside of the shield member 50. The leading end of the separated portion 35 is electrically connected to a metal earth terminal 61, for example. Here, the leading end of the separated portion 35 is the end portion that is the farthest from the rear end portion of the sheath 34, out of end portions in the axial direction of the separated portion 35. The earth terminal 61 is electrically connected to the connector C4 for ground connection, for example. Two earth terminals 61 are connected to the common connector C4, for example. The connector C4 is grounded to the grounding portion C1 provided in the vehicle body panel or the like, for example. With this configuration, each separated portion 35 is grounded to the grounding portion G1 via the earth terminal 61 and the connector C4. The separated portion 35 and the earth terminal 61 can be joined by being crimped or welded through ultrasonic welding or laser welding, or using any other known joining method. Note that the front end portion of each shield member 33 is grounded to a grounding portion G3 of the vehicle V via the connector C3, for example, although this is not illustrated. With the configuration described above, the shield members 33 exhibit an electromagnetic shielding function of suppressing the radiation of electromagnetic waves from the core wires 31 to the outside of the wires 30A and 30B.

Here, at the rear end portion of each of the wires 30A and 30B, the outer peripheries of portions of the insulating covering 32 and the core wire 31 that are located rearward of the separated portion 35 are not surrounded ley the shield member 33. Accordingly, the shield member 33 does not serve as an electromagnetic shield for the rear end portions of the insulating covering 32 and the core wire 31 that are not surrounded by the shield member 33 and are exposed from the shield member 33.

### Configuration of Connection Portion 40

The connection portion 40 includes a connection portion 40A in which the plus side wire 10A is connected to the plus side wires 20A and 30A and a connection portion 40B in which the minus side wire 10B is connected to the minus side wires 20B and 30B. Here, the connection portion 40A and the connection portion 40B have the same structure, and therefore, the connection portions 40A and 40B will be collectively referred to as the connection portion 40. Likewise, the wires 10A and 10B will be collectively referred to as the wire 10, the wires 20A and 20B will be collectively referred to as the wire 20, and the wires 30A and 30B will be collectively referred to as the wire 30.

In the connection portion 40, the core wire 11 of the wire 10 is electrically connected to the core wire 21 of the wire 20 and the core wire 31 of the wire 30. In the connection portion 40, the front end portion of the core wire 11 exposed from the insulating covering 12, the rear end portion of the core wire 21 exposed from the insulating covering 22, the shield member 23, and the sheath 24, and the rear end portion of the core wire 31 exposed from the insulating covering 32, the shield member 33, and the sheath 34 are joined to each other. There is no particular limitation on the method for joining the core wires 11, 21, and 31. For example, the core wires 11, 21, and 31 can be joined by being crimped using a crimp terminal or welded through ultrasonic welding or laser welding, or using any other known joining method. In the present embodiment, the core wires 11, 21, and 31 are joined by being crimped using a crimp terminal 41,

### Configuration of Covering Member 42

The wire harness 1 includes a plurality of covering members 42 that cover the outer periphery of the connection portion 40A and the outer periphery of the connection portion 40B individually, for example.

Each covering member 42 has an elongated tubular shape, for example. Each covering member 42 covers the outer periphery of the crimp terminal 41, the core wire 11 exposed from the insulating covering 12, the core wire 21 exposed from the insulating covering 22, and the core wire 31 exposed from the insulating covering 32, for example. Each covering member 42 is formed so as to span between the front end portion of the insulating covering 12 and the rear end portions of the insulating coverings 22 and 32. For example, the rear end portion of each covering member 42 covers the outer circumferential surface of the front end portion of the insulating covering 12, and the front end portion of each covering member 42 covers the outer circumferential surfaces of the rear end portions of the insulating coverings 22 and 32. Each covering member 42 surrounds the outer periphery of the wire 10, the outer periphery of the wire 20, the outer periphery of the wire 30, and the outer periphery of the crimp terminal 41 over their entire circumferences. Each covering member 42 has a function of maintaining electrical insulation of the connection portion 40 and the core wires 11, 21, and 31 exposed from the insulating coverings 12, 22, and 32, for example.

As the covering members 42, it is possible to use shrinkable tubes, rubber tubes, resin molded articles, hot-melt adhesive, or tape members, for example. The covering members 42 in the present embodiment are heat-shrinkable tubes. As the material of the covering members 42, it is possible to use a synthetic resin that contains a polyolefin resin such as cross-linked polyethylene or cross-linked polypropylene as the main component, for example.

### Configuration of Shield Member 50

The shield member 50 has an elongated tubular shape, for example. The shield member 50 is flexible, for example. A braided wire or a metal foil can be used as the shield member 50, for example. The shield member 50 in the present embodiment is a braided wire. Metal materials such as copper-based materials and aluminum-based materials can be used as the material of the shield member 50, for example.

The shield member 50 is arranged to surround the outer periphery of the connection portion 40. The shield member 50 is arranged to surround the outer peripheries of the connection portions 40A and 40B collectively. The shield member 50 surrounds the outer peripheries of the plurality of covering members 42 over their entire circumferences, for example.

In the present specification, “surround a member A and a member B collectively” means to surround the member A and the member B together using a single tubular member without providing a wall between the member A and the member B, for example.

As shown in FIG. 4, the shield member 50 collectively surrounds the outer peripheries of the plurality of wires 10, i.e., the wires 10A and 10B, for example. The shield member 50 surrounds the outer peripheries of the wires 10A and 10B over their entire circumferences, for example. As shown in FIG. 3, the shield member 50 surrounds the outer peripheries of the wires 10A and 10B over the entire lengths of the wires 10A and 10B in their length directions, for example. The “entire length” as used in the present specification encompasses not only the strict sense of the word “entire length” but also the meaning of “substantially the entire length” within a range in which operations and effects of the present embodiment can be achieved.

The shield member 50 surrounds the outer peripheries of portions of the wires 20A and 20B in their length directions and portions of the wires 30A and 30B in their length directions, for example. For example, the shield member 50 collectively surrounds the outer peripheries of the insulating coverings 22 exposed from the shield members 23 and the outer peripheries of the insulating coverings 32 exposed from the shield members 33. The shield member 50 surrounds the outer peripheries of the rear end portions of the four wires 20A, 20B, 30A, and 30B exposed from the shield members 23 and 33 over their entire circumferences, for example. The shield member 50 surrounds the outer peripheries of portions of the shield members 23 and the outer peripheries of portions of the shield members 33, for example. The shield member 50 surrounds portions of the separated portions 25 of the two wires 20A and 20B and portions of the separated portions 35 of the two wires 30A and 30B, for example. The shield member 50 collectively surrounds the outer peripheries of the rear end portions of the sheaths 24 of the two wires 20A and 20B and the outer peripheries of the rear end portions of the sheaths 34 of the two wires 30A and 30B, for example. As shown in FIG. 5, the shield member 50 surrounds the outer peripheries of the rear end portions of the sheaths 24 of the two wires 20A and 20B and the outer peripheries of the rear end portions of the sheaths 34 of the two wires 30A and 30B over their entire circumferences, for example.

As shown in FIG. 3, the shield member 50 of the present embodiment surrounds a region in the length direction of the wire harness 1 from the rear end portion of the wire 10 to the rear end portions of the sheaths 24 and 34 of the wires 20 and 30.

### Grounding Structure of Shield Member 50

The shield member 50 is grounded to grounding portions of the vehicle V. Both end portions in the axial direction (length direction) of the shield member 50 are grounded, for example. The following describes an example of the grounding structure of the shield member 50.

The rear end portion of the shield member 50 includes a separated portion 51 that does not surround the outer periphery of the wire 10 and extends away from the wire 10, The separated portion 51 extends in a direction (downward in the drawing) that intersects the length direction of the wire 10, for example. The leading end of the separated portion 51 is electrically connected to a metal earth terminal 62, for example. The leading end of the separated portion 51 is grounded to a grounding portion G4 provided in the vehicle body panel or the like via the earth terminal 62, for example. Here, the leading end of the separated portion 51 is the end portion that is the farthest from the wire 10, out of end portions in the axial direction of the separated portion 51. The separated portion 51 and the earth terminal 62 can be joined by being crimped or welded through ultrasonic welding or laser welding, or using any other known joining method.

The front end portion of the shield member 50 includes a separated portion 52 that does not surround the outer peripheries of the wires 20 and 30 and extends away from the wires 20 and 30. The separated portion 52 extends in a direction (downward in the drawing) that intersects the length directions of the wires 20 and 30, for example. The leading end of the separated portion 52 is electrically connected to a metal earth terminal 63, for example. The leading end of the separated portion 52 is grounded to a grounding portion G5 provided in the vehicle body panel or the like via the earth terminal 63, for example. Here, the leading end of the separated portion 52 is the end portion that is the farthest from the wires 20 and 30, out of end portions in the axial direction of the separated portion 52. The separated portion 52 and the earth terminal 63 can be joined by being crimped or welded through ultrasonic welding or laser welding, or using any other known joining method.

With the configuration described above, the shield member 50 exhibits an electromagnetic shielding function of suppressing the radiation of electromagnetic waves from the wire 10 and the connection portion 40 to the outside of the wire harness 1. The shield member 50 exhibits the electromagnetic shielding function of suppressing the radiation of electromagnetic waves from the wires 20 and 30 exposed from the shield embers 23 and 33 to the outside of the wire harness 1.

The shield member 50 includes an opening 53 that is provided in an intermediate portion in the axial direction of the shield member 50. The opening 53 is formed to pass through the shield member 50 in the radial direction of the shield member 50, for example. The opening 53 is formed by widening a mesh in the shield member 50, which is a braided wire, for example. For example, the opening 53 is formed by widening a single mesh in the shield member 50. The opening 53 is formed such that the two separated portions 25 and the two separated portions 35 can pass through the opening 53, for example. Here, the number of openings 53 can be set to a suitable number. For example, a single opening 53 may be provided as in the illustrated case. In this case, the two separated portions 25 and the two separated portions 35, i.e., a total of four separated portions 25 and 35 pass through the single opening 53. The number of openings 53 may be changed to two to four. In the case where four openings 53 are provided, for example, the four separated portions 25 and 35 respectively pass through the four openings 53.

As shown in FIG. 2, the four separated portions 25 and 35 passing through the opening 53 are drawn to the outside of the shield member 50. The leading ends of the separated portions 25 and the leading ends of the separated portions 35 are electrically connected to the earth terminals 60 and the earth terminals 61 respectively outside the shield member 50, for example. The two earth terminals 60 and the two earth terminals 61 are connected to the common connector C4. The leading ends of the separated portions 25 and 35 are grounded to the grounding portion G1 provided in the vehicle body panel or the like via the earth terminals 60 and 61 the connector C4 outside the shield member 50, for example.

In the present embodiment, the shield member 50 is an example of a first shield member (first, shield), the front end portion of the shield member 50 is an example of a first-shield-side first end portion (first-shield-side first end), the shield member 23 is an example of a second shield member (second shield), and the rear end portion of the shield member 23 is an example of a second-shield-side first end portion (second-shield-side first end). Also, the shield member 33 is an example of a third shield member (third shield), and the rear end portion of the shield member 33 is an example of a third-shield-side first end portion (third-shield-side first end).

Next, the following describes the operations and effects of the present embodiment.

(1) The tubular shield member 50 surrounding the outer periphery of the connection portion 40 in which the wires 10, 20, and 30 are electrically connected to each other is provided. With this configuration, the shield member 50 can serve as an electromagnetic shield for the core wire 21 exposed from the shield member 23 in the connection portion 40 and the core wire 31 exposed from the shield member 33 in the connection portion 40. Therefore, it is possible to favorably suppress a reduction in the electromagnetic shielding performance in the connection portion 40. Consequently, the radiation of electromagnetic noise generated in the connection portion 40 to the outside of the wire harness 1 can be favorably suppressed.

(2) The rear end portions of the shield members 23 and the rear end portions of the shield members 33 are drawn to the outside of the shield member 50 from the opening 53 provided in the intermediate portion in the axial direction of the shield member 50. With this configuration, the shield members 23 and 33 can be favorably electrically connected to the grounding portion G1 outside the shield member 50. Consequently, the shield members 23 and 33 can favorably function as electromagnetic shield members, That is, the shield members 23 and 33 can favorably exhibit the electromagnetic shielding functions.

(3) The shield member 50 is arranged to surround the outer peripheries of portions of the shield members 23 and 33, and the rear end portions of the shield members 23 and 33 are drawn out from the opening 53 provided in the intermediate portion in the axial direction of the shield member 50. With this configuration, the region from the connection portion 40 to the rear end portions of the shield members 23 and 33 can be surrounded by the shield member 50, and accordingly, the core wires 21 and 31 exposed from the rear end portions of the shield members 23 and 33 can be favorably kept from being exposed from the shield member 50. In other words, the shield member 50 can favorably serve as an electromagnetic shield for the core wires 21 and 31 exposed from the rear end portions of the shield members 23 and 33. Consequently, a reduction in the electromagnetic shielding performance can be favorably suppressed in the region from the connection portion 40 to the rear end portions of the shield members 23 and 33.

(4) The shield member 50 is arranged to surround the outer peripheries of the rear end portions of the sheaths 24 and 34. With this configuration, the region from the connection portion 40 to the sheaths 24 and 34 in the length directions of the wires 20 and 30 can be surrounded by the shield member 50. Here, the sheath 24 surrounds the outer periphery of the shield member 23 and the sheath 34 surrounds the outer periphery of the shield member 33. Accordingly, the region from the portion of the core wire 21 surrounded by the shield member 23 and the sheath 24 to the connection portion 40 can be surrounded by the shield member 50. Also, the region from the portion of the core wire 31 surrounded by the shield member 33 and the sheath 34 to the connection portion 40 can be surrounded by the shield member 50. Therefore, it is possible to favorably suppress a reduction in the electromagnetic shielding performance in the region from the connection portion 40 to the rear end portions of the sheaths 24 and 34.

(5) The shield member 50 is arranged to surround the outer periphery of the wire 10, which is an unshielded wire. Therefore, the shield member 50 can favorably serve as an electromagnetic shield for the wire 10. In other words, even in the case where the wire 10 is an unshielded wire, the shield member 50 serves as an electromagnetic shield for the wire 10, and therefore, it is possible to favorably suppress a reduction in the electromagnetic shielding performance in the wire harness 1.

(6) The leading ends of the separated portions 25 of the shield members 23 and the leading ends of the separated portions 35 of the shield members 33 are collectively electrically connected to the grounding portion C1. Accordingly, the number of grounding sites can be reduced when compared with a case where the leading ends of the separated portions 25 and the leading ends of the separated portions 35 are electrically connected to different grounding portions. Therefore, it is possible to reduce the number of fastening points at which grounding members such as the earth terminals 60 and 61 are fastened to grounding portions such as the grounding portion G1.

(7) The connector C1 is electrically connectable to the external connector 101 that is connected to the external power source 100. In this case, a large current flows through the wire 10 that is electrically connected to the connector C1, and accordingly, electromagnetic noise is likely to be generated in the wire 10 and the connection portion 40. However, in the wire harness 1 of the present embodiment, the outer periphery of the connection portion 40 is surrounded by the shield member 50 to suppress a reduction in the electromagnetic shielding performance in the connection portion 40. Therefore, even in the case where electromagnetic noise is likely to be generated, it is possible to favorably suppress the radiation of electromagnetic noise generated from the connection portion 40 to the outside of the wire harness 1.

### Other Embodiments

The above embodiment can be implemented with the following changes, The above embodiment and the following variations can be implemented in combination so long as no technical contradiction is incurred.

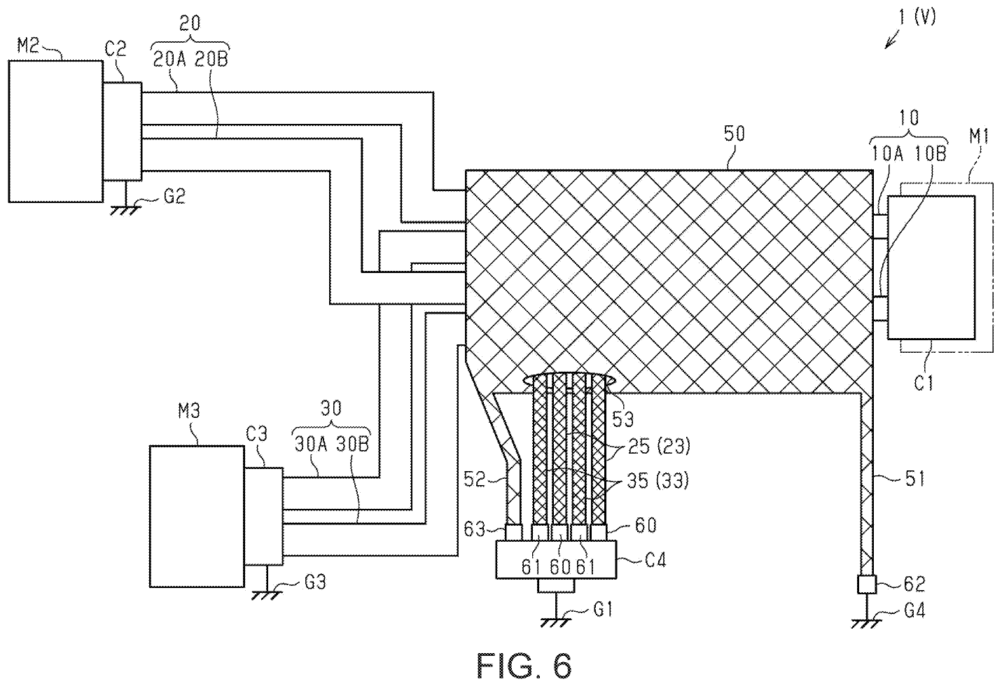

As shown in FIG. 6, the front end portion of the shield member 50 may be electrically connected to the connector C4. For example, it is possible to electrically connect the earth terminal 63 to the leading end of the separated portion 52 and connect the earth terminal 63 to the connector C4. In this case, the two separated portions 25, the two separated portions 35, and the separated portion 52 are electrically connected to the connector C4. The connector C4 is electrically connected to the grounding portion G1.

In this configuration, the leading end of the separated portion 52 of the shield member 50, the leading ends of the separated portions 25 of the shield members 23, and the leading ends of the separated portions 35 of the shield members 33 are collectively electrically connected to the grounding portion G1. Therefore, the number of grounding sites can be further reduced when compared with the case where the leading end of the separated portion 52, the leading ends of the separated portions 25, and the leading ends of the separated portions 35 are electrically connected to different grounding portions.

In the above embodiment, a grounding member (ground) for electrically connecting the separated portions 25 and 35 collectively to the grounding portion G1 is embodied as the earth terminals 60 and 61 respectively connected to the leading ends of the separated portions 25 and 35 and the connector C4 to which the earth terminals 60 and 61 are connected. However, the structure of the grounding member is not limited to this structure,

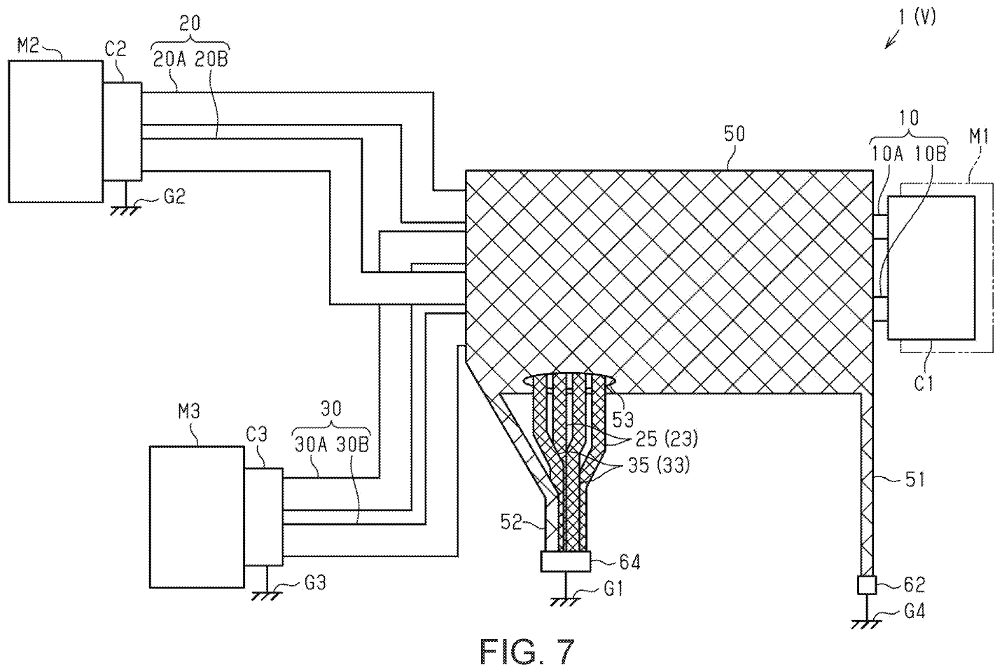

For example, as shown in FIG. 7, the grounding member may be embodied as an earth terminal 64 for crimping the leading ends of the separated portions 25 and the leading ends of the separated portions 35 together. The earth terminal 64 of this variation crimps the leading ends of the two separated portions 25 and the leading ends of the two separated portions 35 together. The earth terminal 64 of this variation crimps the leading ends of the two separated portions 25, the leading ends of the two separated portions 35, and the leading end of the separated portion 52 together. The earth terminal 64 is electrically connected to the grounding portion G1. With this configuration, the separated portions 25, 35, and 52 can be collectively electrically connected to the grounding portion G1.

In the above embodiment, the separated portions 25 and the separated portions 35 are collectively electrically connected to the single grounding portion G1, but there is no limitation to this configuration. For example, the separated portions 25 and the separated portions 35 may be electrically connected to different grounding portions. In this case, the separated portions 25 and the separated portions 35 may be drawn in different directions from the inside of the shield member 50.

In the above embodiment, the separated portion 51 is provided in the rear end portion of the shield member 50 and the earth terminal 62 is electrically connected to the leading end of the separated portion 51. However, the grounding structure for grounding the rear end portion of the shield member 50 to the grounding portion G4 is not limited to this structure.

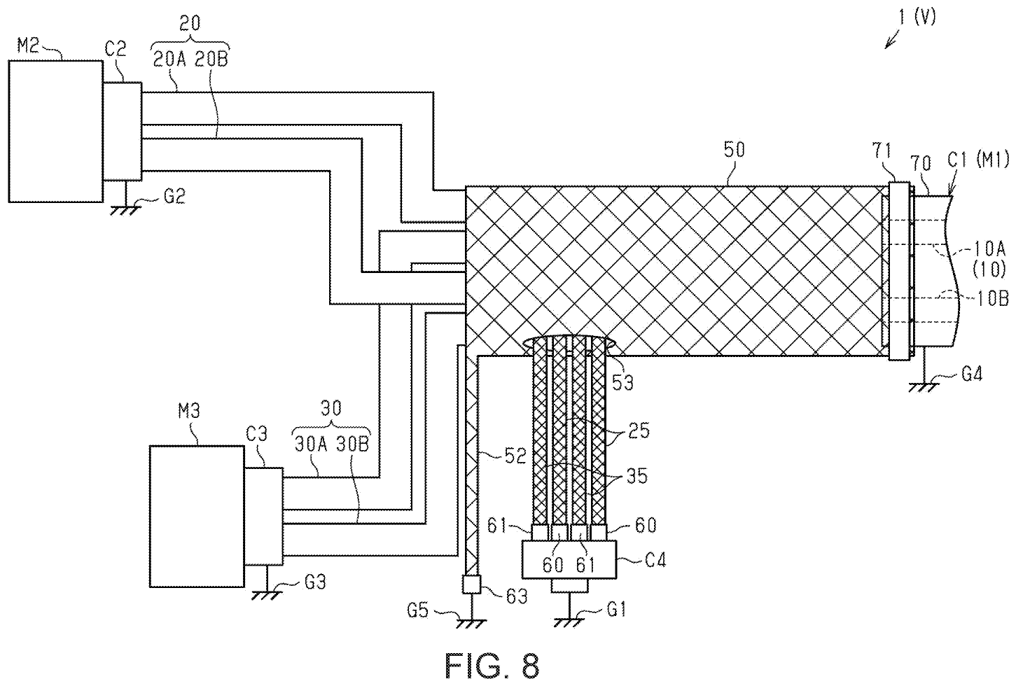

For example, as shown in FIG. 8, it is possible to provide a metal tubular member 70 on the connector and electrically connect the rear end portion of the shield member 50 to the tubular member 70. The tubular member 70 surrounds the outer periphery of the rear end portion of the wire 10. In other words, the rear end portion of the wire 10 is housed in the tubular member 70.

The rear end portion of the shield member 50 surrounds the outer periphery of the tubular member 70. The rear end portion of the shield member 50 surrounds the outer periphery of the tubular member 70 over its entire circumference. The wire harness 1 of this variation includes a fixing member 71 for fixing the rear end portion of the shield member 50 to the tubular member 70, The fixing member 71 fixes the rear end portion of the shield member 50 to the outer circumferential surface of the tubular member 70 in a state where the rear end portion of the shield member 50 is in contact with the tubular member 70, for example. The fixing member 71 is fixed to the outer circumferential surface of the shield member 50. The fixing member 71 has a tubular shape that conforms to the outer circumferential surface of the tubular member 70. The fixing member 71 is fitted on the outer side of the tubular member 70 with the rear end portion of the shield member 50 sandwiched between the fixing member 71 and the outer circumferential surface of the tubular member 70. As a result of the fixing member 71 being tightened radially inward of the tubular member 70, the rear end portion of the shield member 50 is fixed in the state of being in direct contact with the outer circumferential surface of the tubular member 70. Thus, the shield member 50 is electrically and mechanically connected to the tubular member 70. The shield member 50 of this variation is grounded to the grounding portion G4 via the tubular member 70. For example, a caulking ring, a cable tie, or a tape member can be used as the fixing member 71. Metal materials such as iron-based materials, aluminum-based materials, and copper-based materials can be used as the material of the caulking ring, for example.

In this configuration, the rear end portion of the shield member 50 surrounds the outer periphery of the tubular member 70 provided on the connector C1, and accordingly, the rear end portion of the wire 10 connected to the connector C1 can be kept from being exposed from the shield member 50. Therefore, it is possible to favorably suppress a reduction in the electromagnetic shielding performance around the connector C1.

In the wire harness 1 of the above embodiment, the two branch wires 20 and 30 branch from the trunk wire 10, but there is no limitation to this configuration. For example, three or more branch wires may branch from the trunk wire 10.

In the above embodiment, the wire 10 is embodied as an unshielded wire, but the wire 10 may be embodied as a shielded wire. For example, all of the wires 10, 20, and 30 may be embodied as shielded wires.

In the above embodiment, the wire 10 is embodied as an unshielded wire and the wires 20 and 30 are embodied as shielded wires, but there is no limitation to this configuration. For example, a configuration is also possible in which the wires 10 and 20 are embodied as unshielded wires and the wire 30 is embodied as a shielded wire. In this case, the shield member 50 is arranged to surround the region from the rear end portion of the wire 10 to the front end portion of the wire 20, for example. Also, in this variation, only the separated portions 35 of the shield members 33 are drawn to the outside of the shield member 50 from the opening 53 of the shield member 50.

In the wire harness 1 of the above embodiment, an outer covering member that surrounds the outer peripheries of the wires 10, 20, and 30 may also he provided. As the outer covering member, it is possible to use a metal pipe, a resin pipe, a corrugated tube, a waterproof cover made of rubber, or a combination of any of these, for example.

In the above embodiment, the wire 10 is constituted by the two wires 10A and 10B, the wire 20 is constituted by the two wires 20A and 20B, and the wire 30 is constituted by the two wires 30A and 30B, but there is no limitation to this configuration. The number of wires constituting the wires 10, 20, and 30 can be changed according to the specifications of the vehicle V. For example, the wires 10, 20, and 30 may be constituted by three or more wires.

In the above embodiment, both of the in-vehicle devices M2 and M3 are embodied as batteries, but there is no limitation to this configuration, For example, a configuration is also possible in which one of the in-vehicle devices M2 and M3 is embodied as a battery and the other of the in-vehicle devices M2 and M3 is embodied as a power supply device that supplies direct current power to the charging inlet M1. For example, a DC-DC converter can be used as the power supply device.

In the above embodiment, the in-vehicle devices M2 and M3 are embodied as batteries, but there is no limitation to this configuration. There is no particular limitation on the in-vehicle devices M2 and M3 so long as the in-vehicle devices M2 and M3 are electrical devices installed in the vehicle V.

In the above embodiment, the connector C1 is embodied as a connector (charging connector) that constitutes the charging inlet M1, but there is no limitation to this configuration. For example, the connector C1 may be embodied as a connector that is provided in an in-vehicle device other than the charging inlet M1. Also, the connector C1 may be embodied as a connector that is electrically connected to an in-vehicle device other than the charging inlet M1.

The arrangement relationship between the charging inlet M1 and the in-vehicle devices M2 and M3 in the vehicle V is not limited to that in the above embodiment, and may be changed as appropriate according to the configuration of the vehicle V.

The disclosed embodiment is an illustrative example in all aspects and should not be considered as restrictive. The scope of the present disclosure is defined not by the above descriptions but by the claims, and is intended to encompass all modifications within the meanings and scope that are equivalent to the claims.

What is claimed is:

1. A wire harness comprising:
a first wire that is electrically connectable to a first connector installed in a vehicle;
a second wire that is electrically connected to the first wire;
a third wire that is electrically connected to the first wire;
a connection where the first wire, the second wire, and the third wire are electrically connected to each other; and
a tubular first shield that surrounds an outer periphery of the connection, wherein:
an opening is provided in an intermediate portion in an axial direction of the first shield,
the second wire is a shielded wire that includes a tubular second shie
the first shield surrounds an outer periphery of a portion of the second shield, and
a second-shield-side first end in an axial direction of the second shield is drawn to an outside of the first shield from the opening.

2. The wire harness according to claim 1, wherein:
the first wire includes a conductive first core wire and a first insulating covering that surrounds an outer periphery of the first core wire and has insulating properties,
the second wire includes a conductive second core wire, a second insulating covering that surrounds an outer periphery of the second core wire and has insulating properties, the second shield surrounding an outer periphery of the second insulating covering and is conductive, and a first sheath that surrounds the outer periphery of the second shield and has insulating properties,
the third wire includes a conductive third core wire, a third insulating covering that surrounds an outer periphery of the third core wire and has insulating properties, a tubular third shield that surrounds an outer periphery of the third insulating covering and is conductive, and a second sheath that surrounds an outer periphery of the third shield and has insulating properties,
in the connection, the first core wire exposed from the first insulating covering, the second core wire exposed from the second insulating covering, the second shield and the first sheath, and the third core wire exposed from the third insulating covering, the third shield and the second sheath are electrically connected to each other,
the first shield surrounds the outer periphery of a portion of the third shield member, and
a third-shield-side first end in an axial direction of the third shield is drawn to the outside of the first shield member from the opening.

3. The wire harness according to claim 2, wherein:
the second-shield-side first end of the second shield is exposed from the first sheath,
the second-shield-side first end of the second shield includes a first separation that does not surround the outer peripheries of the second core wire and the second insulating covering and extends away from the second core wire and the second insulating covering,
the third-shield-side first end of the third shield is exposed from the second sheath,
the third-shield-side first end of the third shield includes a second separation that does not surround the outer peripheries of the third core wire and 25, the third insulating covering and extends away from the third core wire and the third insulating covering,
the first shield surrounds the outer periphery of the second core wire exposed from the second shield and the outer periphery of the third core wire exposed from the third shield, and
the first separation and the second separation are drawn to the outside of the first shield member from the opening.

4. The wire harness according to claim 3, wherein the first shield surrounds an outer periphery of a portion of the first sheath and an outer periphery of a portion of the second sheath,

5. The wire harness according to claim 2, wherein;
the first wire is an unshielded wire that does not have its own electromagnetic shielding structure, and
the first shield surrounds the outer periphery of the first wire.

6. The wire harness according to claim 2, further comprising a ground that electrically connects the second-shield-side first end of the second shield and the third-shield-side first end of the third shield collectively to a grounding portion.

7. The wire harness according to claim 6, wherein the ground electrically connects a first-shield-side first end in the axial direction of the first shield, the second-shield-side first end of the second shield, and the third-shield-side first end of the third shield collectively to the grounding portion.

8. The wire harness according to claim 6, wherein the ground includes:
a first earth terminal that is electrically connected to the second-shield-side first end of the second shield;
a second earth terminal that is electrically connected to the third-shield-side first end of the third shield; and
a second connector that is electrically connected to the first earth terminal and the second earth terminal.

9. The wire harness according to claim 1, wherein the first connector is electrically connectable to an external connector that is connected to an external. power source.
